(19) United States
(12) Patent Application Publication
(10) Pub. No.: US 2026/0245771 A1
(43) Pub. Date: Aug. 20, 2026

(54) Electric Vehicle Charging Cable

(71) Applicant: ABB E-Mobility B.V., Delft (NL)

(72) Inventors: Nikhil Varma Padayambath, Rotterdam (NL); Himanshu Bindal, Milwaukee, WI (US)

(21) Appl. No.: 19/054,360

(22) Filed: Feb. 14, 2025

(51) Int. Cl. H01B 7/42; B60L 53/18; B60L 53/302; H01B 9/00

(52) U.S. Cl. CPC H01B 7/423; B60L 53/18; B60L 53/302; H01B 9/00

(57) ABSTRACT

A charging cable for electric vehicles is described. The charging cable includes a tubular housing having a first end and a second end and a plurality of conduits extending between the first end and the second end within the tubular housing. The plurality of conduits includes a plurality of first conduits, each first conduit comprising a first coolant channel configured to enable the flow of coolant between the first end and the second end in a first direction and at least one second conduit, each second conduit comprising a second coolant channel configured to enable the flow of coolant between the first end and the second end in a second direction. The charging cable also includes at least one fluid disturbance mechanism disposed within at least one of each first coolant channel and each second coolant channel.

### TECHNICAL FIELD

The field of disclosure relates generally to charging cables, and more particularly, to electric vehicle charging cables.

### BACKGROUND

Currently in the industry, high power charging systems are used for delivering high power capacities that enable the rapid charging of electric vehicles. However, certain components within these high power charging systems may limit the power delivery capabilities of the high power charging systems. For example, one such component may be the connector used to establish a connection between the high power charging systems and the electric vehicle to be charged. More specifically, the connector may only be capable of delivering a specified amount of power during a charging event. In cases when the specified amount of power delivered is exceeded, the connector may overheat. The overheated connector may produce unsafe operating conditions for the charging system and electric vehicle.

Based on the foregoing, a need exists for a charging cable that allows charging connectors to handle increased amounts of power supplied by the high power charging systems without overheating.

This background section is intended to introduce the reader to various aspects of art that may be related to various aspects of the present disclosure, which are described and/or claimed below. This discussion is believed to be helpful in providing the reader with supporting information to facilitate a better understanding of the various aspects of the present disclosure. Accordingly, it should be understood that these statements are to be read in this light, and not as admissions of prior art.

### BRIEF DESCRIPTION

In one aspect, a charging cable for electric vehicles is described. The charging cable includes a tubular housing having a first end and a second end and a plurality of conduits extending between the first end and the second end within the tubular housing. The plurality of conduits includes a plurality of first conduits, each first conduit comprising a first coolant channel configured to enable the flow of coolant between the first end and the second end in a first direction and at least one second conduit, each second conduit comprising a second coolant channel configured to enable the flow of coolant between the first end and the second end in a second direction. The charging cable also includes at least one fluid disturbance mechanism disposed within at least one of the first coolant channel and the second coolant channel.

In another aspect, a charging cable for electric vehicles is described. The charging cable includes a tubular housing having a first end and a second end and a plurality of conduits extending between the first end and the second end within the tubular housing. The plurality of conduits includes a plurality of first conduits, each first conduit comprising a first coolant channel configured to enable the flow of coolant between the first end and the second end in a first direction and at least one second conduit, each second conduit comprising a second coolant channel configured to enable the flow of coolant between the first end and the second end in a second direction. The charging cable also includes at least one fluid disturbance mechanism disposed within at least one of the first coolant channel and the second coolant channel. Additionally, the charging cable comprises a charging connector coupled to the distal end of the tubular housing, the charging connector configured to couple the charging cable to an electric vehicle.

In yet another aspect, a charging system for an electric vehicle is described. The charging system comprises a charging system housing and a charging cable coupled to the charging system housing. The charging cable includes a tubular housing having a first end and a second end and a plurality of conduits extending between the first end and the second end within the tubular housing. The plurality of conduits includes a plurality of first conduits, each first conduit comprising a first coolant channel configured to enable the flow of coolant between the first end and the second end in a first direction and at least one second conduit, each second conduit comprising a second coolant channel configured to enable the flow of coolant between the first end and the second end in a second direction. The charging cable also includes at least one fluid disturbance mechanism disposed within at least one of the first coolant channel and the second coolant channel. Additionally, the charging cable comprises a charging connector coupled to the distal end of the tubular housing, the charging connected configured to couple the charging cable to an electric vehicle.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 depicts a perspective view of a charging system for an electric vehicle, as described herein;

FIG. 2 depicts a lateral cross-sectional view of an exemplary charging cable for the charging system of FIG. 1;

FIG. 3 depicts a sectional perspective view of a portion of an exemplary charging cable with a charging connector for use in the charging system for an electric vehicle of FIG. 1;

FIG. 4 depicts a lateral cross-sectional view of the charging cable of FIG. 3;

FIG. 5 depicts a perspective view of an exemplary coolant flow path through the exemplary charging cable and the charging connector of FIG. 3;

FIG. 6 depicts a longitudinal cross-sectional view of the charging cable of FIG. 3, showing a first conduit and a second conduit;

FIG. 7 depicts a sectional perspective view of a portion of a charging cable with an exemplary charging connector for use in the charging system for an electric vehicle of FIG. 1;

FIG. 8 depicts a lateral cross-sectional view of the charging cable of FIG. 7;

FIG. 9 depicts a perspective view of an exemplary coolant flow path through the exemplary charging cable and the charging connector of FIG. 7;

FIG. 10 depicts a longitudinal cross-sectional view of the charging cable of FIG. 6, showing a first conduit and a second conduit;

FIG. 11A depicts a magnified detailed view of area 11A of FIG. 10 showing a portion of a first conduit with an exemplary fluid disturbance mechanism included in the coolant channel of the first conduit; and

FIG. 11B depicts a magnified detailed view of area 11B of FIG. 10 showing a portion of a first conduit with an exemplary fluid disturbance mechanism included in the coolant channel of the first conduit.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The exemplary embodiments disclosed herein describe an advantageous charging cable for electric vehicles. The charging cable enables enhanced cooling of charging cable conductors to minimize hotspots within charging systems to allow the charging system to deliver greater amounts of power to electric vehicles. The charging cable includes at least one fluid disturbance mechanism, positioned within a coolant channel. The fluid disturbance mechanism disturbs the flow of coolant in the coolant channel and, thereby, produces enhanced mixing of the coolant which in turn enables enhanced cooling downstream of the at least one fluid disturbance mechanism. The enhanced cooling enables a charging connector for connecting the charging system with an electric vehicle to be cooled more effectively and allow the charging connector to handle and deliver greater amounts of power to the electric vehicle without creating an overheating level that could negatively impact the charging system or electric vehicle.

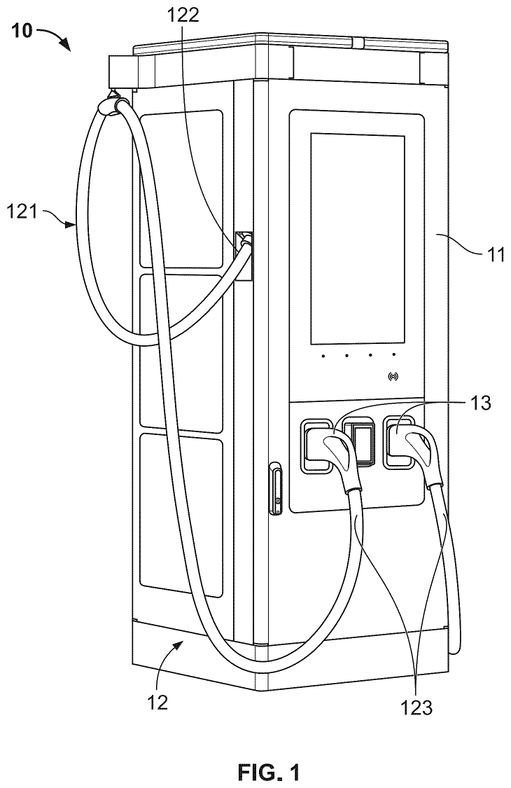

FIG. 1 depicts a perspective view of a charging system 10 for use by an electric vehicle (not shown). The charging system 10 includes a charging system housing 11. The charging system 10 is configured to supply electrical power to charge an electric vehicle. In some embodiments, the charging system 10 may include components (not shown) located within charging system housing 11 that convert electrical power input from a power grid to a specified voltage and/or current for use during charging of an electric vehicle. For example, within the charging system housing 11 may be, but not limited to a transformer (not shown) and/or a rectifier (not shown).

Charging system 10 may include control components (not shown) located within the charging system housing 11. The control components may be configured to control the charging system 10 to enable the charging system 10 to efficiently deliver power to an electric vehicle. Some exemplary control components may include a microcontroller, voltage sensors, current sensors, and the like. Control components may be used to communicate with the electric vehicle to receive information about the state of charge of the electric vehicle. Such information may include charging rate, battery state, and the like. Additionally, control components may be used to manage ongoing charging processes. For example, control components may be used to monitor status data, such as charging system housing temperature, electric vehicle battery temperature, voltages, currents, and the like, and adjust voltages and currents supplied to the vehicle battery based on the status data.

Additionally, the charging system 10 may include a cooling system that is at least partially located within the housing 11. The cooling system provides enhanced cooling of the charging system that in turn allows the charging system 10 to supply greater amounts of power to a charging vehicle without overheating of the charging system 10 and/or components described herein. The cooling system may comprise a closed loop cooling system. The closed loop cooling system may be configured to circulate a coolant through and/or proximate the components located in the charging system housing 11, such as the components described above. The cooling system may circulate coolant through a charging cable, such as charging cable 12 shown in FIG. 1. The charging cable 12 is shown in FIGS. 1-10 and described in more detail herein. In an embodiment, the coolant in the cooling system may comprise a mixture of water and glycol. The circulation of the coolant may be used to manage heat generated during use of the charging system 10.

The charging system 10 may include at least one charging cable 12 connected to the charging system housing 11. In an embodiment, the charging system may comprise any number of charging cables 12. Each charging cable may comprise the cooling system described herein. For example, as shown in FIG. 1, the charging system 10 may include two charging cables 12 with each charging cable 12 coupled to a corresponding portion of the charging system housing 11. Each charging cable 12 includes an elongate tubular body 121 having a first end 122 connected to the housing 11 and a second end 123 that includes a charging connecter 13 that may be seated in the housing when not in use (e.g., when the charging connector 13 is not plugged into an electric vehicle). See FIG. 1.

As shown in FIG. 1, the charging connector 13 is coupled to the second end 123 of the tubular body 121. The charging connector 13 is configured to be coupled to an electric vehicle to supply the electric power from the charging system 10 to the electric vehicle to charge the electric vehicle. In some embodiments, the charging connector 13 may comprise a connector body configured to enclose the discrete components of the charging connector 13 and align the charging connector 13 with a corresponding charging receptacle on the electric vehicle. For example, one exemplary component enclosed by the housing may be at least one pin (not shown) configured to create a connection, such as an electrical connection, with the electric vehicle through a corresponding port on the electric vehicle when charging connector 13 is plugged into the corresponding inlet on the electrical vehicle.

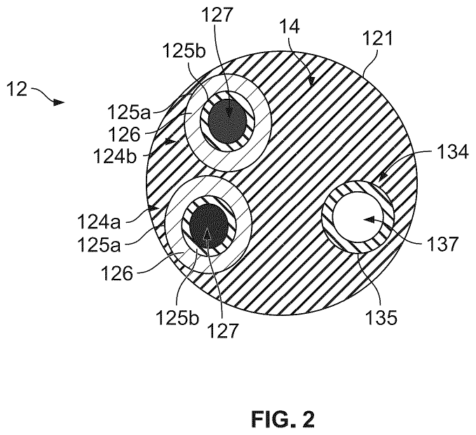

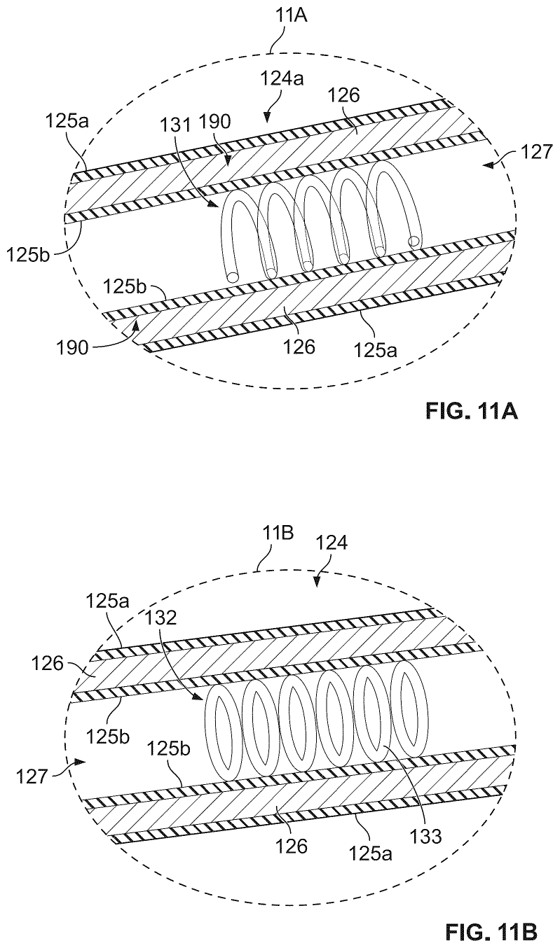

FIG. 2 depicts a lateral cross-sectional view taken along the length of the body of the charging cable 12 between the first and second cable ends 122, 123 respectively. As shown in FIG. 2, the charging cable 12 includes an insulating material 14 and at least two first conduits 124a, 124b, collocated with the insulating material 14 within the tubular body 121. Each of the insulating material 14 and the first conduits 124a, 124b extend between the first end 122 and the second end 123 within the tubular body 121 to allow electrical power and/or coolant to be supplied between the charging system housing 11 and the charging connector 13. In an example, insulating material 14 may be a thermal plastic material such as cross-linked polyethylene, thermal plastic elastomer, and the like. However, insulating material 14 is not limited thereto and may be any material with suitable electrical insulating properties. In some embodiments, each first conduit 124a, 124b may comprise an outer conduit recess 190, shown in FIG. 11A, that is defined between an outer first conduit wall 125a and an inner second conduit wall 125b. A conductor 126 is located in each recess 190. Each conductor 126 extends between the cable ends 122 and 123. Each conductor 126 may be configured to enable the flow of electrical power supplied by the charging system 10 to the charging connector 13 for use in charging electric vehicles. The second conduit wall 125b may additionally define a coolant channel 127. The coolant channel 127 enables the flow of coolant through the charging cable 12 during circulation of the coolant for use in cooling of the charging connector 13 and other system 10 components. Each first conduit 124a, 124b comprises a coolant channel 127 configured to enable the flow of the coolant between the first end 122 and the second end 123 of the cable. Each coolant channel 127 may be configured to enable the flow of coolant in a first specified direction. For example, coolant channel 127 may be configured to enable the flow of coolant from a charging connector 13 to the charging system housing 11 to draw heat away from the charging connector 13, as shown in FIG. 6. In a further example, coolant channel 127 may be configured to enable the flow of coolant from the charging system housing 11 to a charging connector 13 prior to circulation of the coolant through the charging connector 13 for cooling of the charging connector 13, as shown in FIG. 10.

As shown in FIG. 2, the charging cable 12 includes at least one second conduit 134, collocated with the insulating material 14 within the tubular body 121. Similar to each of the insulating material 14 and the first conduits 124a, 124b, the at least one second conduit 134 extends between the first end 122 and the second end 123 within the tubular body 121 to allow coolant to be supplied between the charging system housing 11 and the charging connector 13. The second conduit 134 comprises a conduit wall 135. The conduit wall 135 may additionally define a coolant channel 137. The coolant channel 137 enables the flow of coolant through the charging cable 12 during circulation of the coolant for use in cooling of the charging connector 13 and other system 10 components. Each second conduit 134 comprises a coolant channel 137 configured to enable the flow of the coolant between the first end 122 and the second end 123 of the cable. Each coolant channel 137 may be configured to enable the flow of coolant in a second specified direction that is opposite of the first specified direction of coolant flow enabled by each coolant channel 127. For example, in an embodiment, coolant channel 137 may be configured to enable the flow of coolant from the charging system housing 11 to the charging connector 13 for use in cooling of the charging connector 13, as shown in FIG. 6. Consequently, in such an embodiment, coolant channel 127 may be configured to enable the flow of coolant from a charging connector 13 to the charging system housing 11 to draw heat away from the charging connector 13, as described above. In a further example, coolant channel 127 may be configured to enable the flow of coolant from the charging system housing 11 to a charging connector 13 prior to circulation of the coolant through the charging connector 13 for cooling of the charging connector, as described above. Consequently, in such an embodiment, coolant channel 137 may be configured to enable the flow of coolant from the charging connector 13 to the charging system housing 11 to draw heat away from the charging connector 13, as shown in FIG. 10.

In some embodiments, second conduit 134 may comprise an outer conduit wall, similar to first conduit wall 125a, and a second outer conduit recess (not shown), similar to outer conduit recess 190, that is defined between the outer conduit wall and the conduit wall 135. A conductor (not shown), similar to conductor 126, may be located in the outer conduit recess defined between the outer conduit wall and the conduit wall 135. The conductor may extend between the cable ends 122 and 123. Similar to conductor 126, the conductor of the second conduit 134 may also be configured to enable the flow of electrical power supplied by the charging system 10 to the charging connector 13 for use in charging electric vehicles.

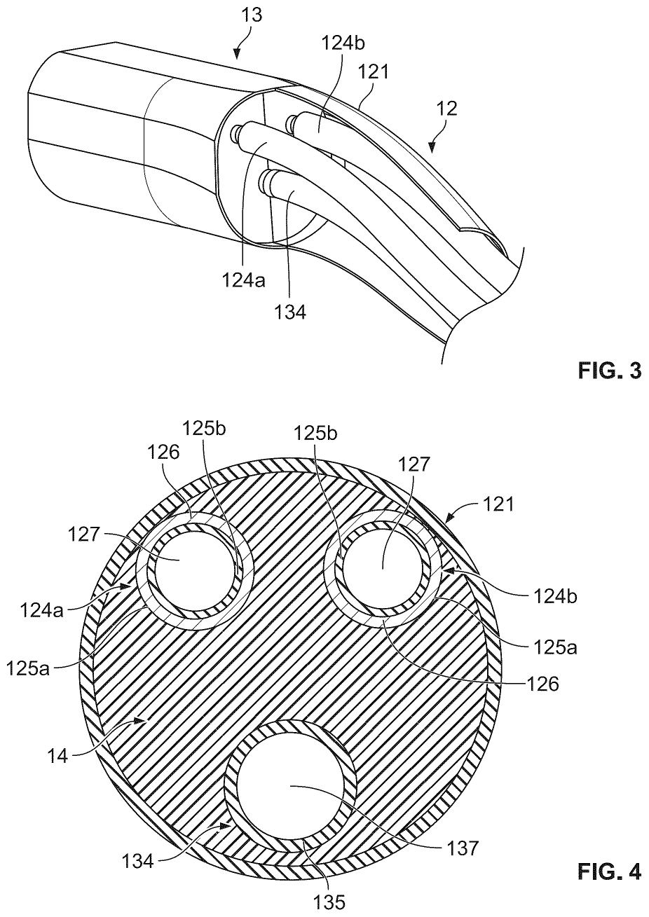

Additionally, charging system housing 11 may include at least one coupling 128, as shown in FIGS. 6 and 10. The charging system housing 11 may include any number of couplings 128 to correspond with each of the at least two first conduits 124a, 124b and the at least one second conduit 134 in charging cable 12. For example, the charging system housing 11 may include three couplings to correspond to each of the pair of first conduits 124a, 124b and the second conduit 134 of FIG. 3. The at least one coupling 128 may be disposed on a portion of the charging system housing 11 to receive a charging cable, such as charging cable 12, at the first cable end 122. Each first conduit 124 may be configured to receive, at the first end 122 of charging cable 12, a corresponding coupling 128 to create a connection, such as a fluidic connection, between the first conduit 124 and a portion of the cooling system located within the charging system housing 11. More specifically, each the second conduit wall 125b may be configured to receive, at the first end 122 of charging cable 12, coupling 128 and create a fluidic connection between the coolant channel 127 and a portion of the cooling system located within the charging system housing 11. Each second conduit 134 may be configured to receive, at the first end 122 of charging cable 12, a corresponding coupling 128 to create a connection, such as a fluidic connection, between the second conduit 134 and a portion of the cooling system located within the charging system housing 11. More specifically, each conduit wall 135 may be configured to receive, at the first end 122 of charging cable 12, coupling 128 and create a fluidic connection between the coolant channel 137 and a portion of the cooling system located within the charging system housing 11.

The fluidic connection between the first conduit 124 and a portion of the cooling system located within the charging system housing 11 may allow the coolant channel 127 to receive coolant from the portion of the cooling system within the charging system housing 11 or return coolant into the portion of the cooling system within charging system housing 11 during circulation of the coolant within the cooling system based a coolant flow direction enabled by the coolant channel 127. Additionally, the fluidic connection between the second conduit 134 and a portion of the cooling system located within the charging system housing 11 may allow the coolant channel 137 to receive coolant from the portion of the cooling system within the charging system housing 11 or return coolant into the portion of the cooling system within charging system housing 11 during circulation of the coolant within the cooling system based a coolant flow direction enabled by the coolant channel 137.

Additionally, charging connector 13 may include at least one coupling 129, as shown in FIGS. 6 and 10. The charging connector 13 may include any number of couplings 129 to correspond with each of the at least two first conduits 124a, 124b and the at least one second conduit 134 in charging cable 12. For example, the charging system housing 11 may include three couplings to correspond to each of the pair of first conduits 124a, 124b and the second conduit 134 of FIG. 3. The at least one coupling 129 may be disposed on a portion of the charging connector 13 proximal to the second cable end 123. Each first conduit 124 may be configured to receive, at the second end 123, a corresponding coupling 129 to create a connection, such as a fluidic connection, between the first conduit 124 and a coolant flow path within the charging connector 13. More specifically, each of the second conduit wall 125b and the conduit wall 135 may be configured to receive, at the second end 123 of charging cable 12, coupling 129 and create a fluidic connection between the coolant channel 127 and a coolant flow path within the charging connector 13. Each second conduit 134 may be configured to receive, at the second end 123 of charging cable 12, a corresponding coupling 129 to create a connection, such as a fluidic connection, between the second conduit 134 and a coolant flow path within the charging connector 13. More specifically, each of the second conduit wall 125b and the conduit wall 135 may be configured to receive, at the second end 123 of charging cable 12, coupling 129 and create a fluidic connection between the coolant channel 127 and a coolant flow path within the charging connector 13 and between the coolant channel 137 and a coolant flow path within the charging connector 13, respectively.

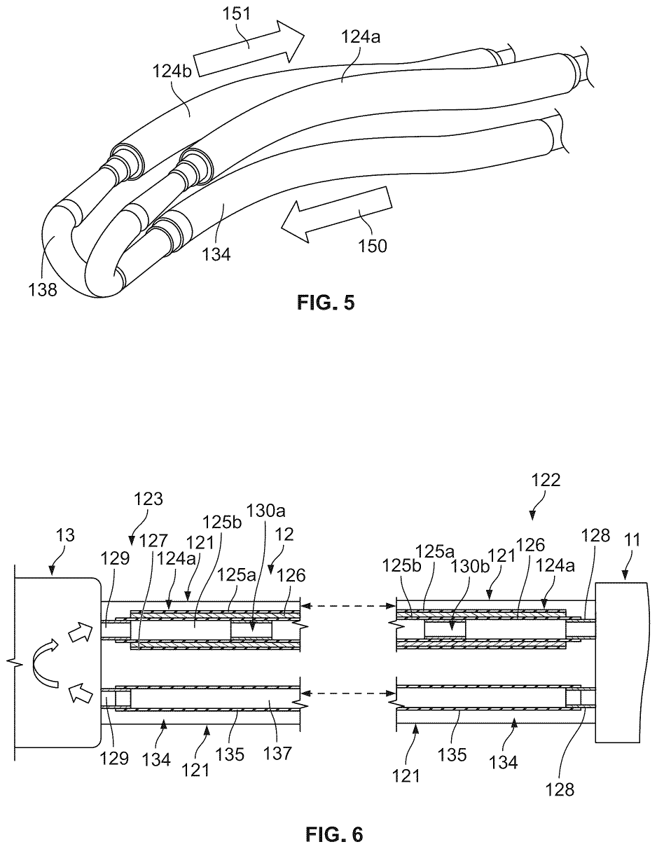

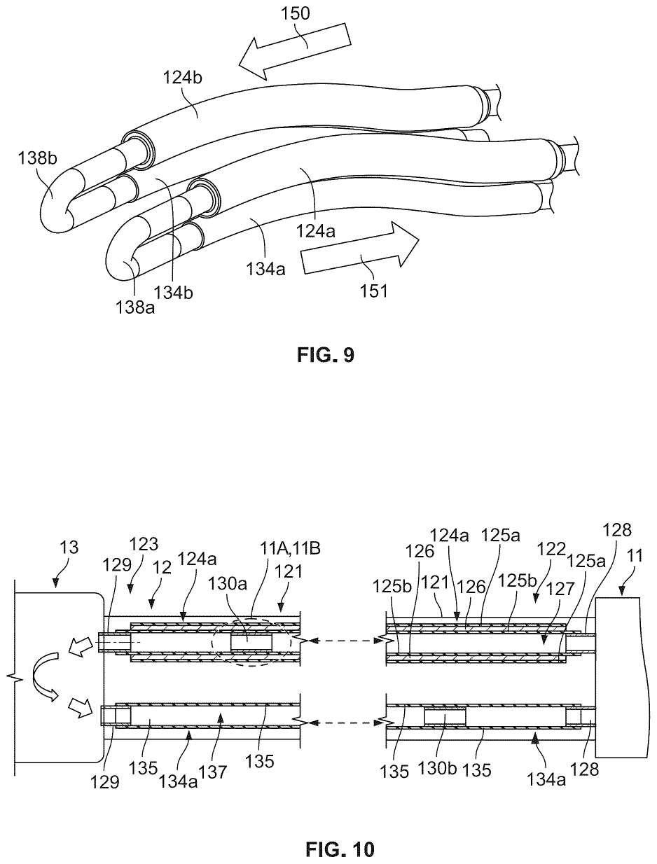

The fluidic connection between the first conduit 124 and the coolant flow path within the charging connector 13 may allow the coolant channel 127 and the coolant channel 137 to direct coolant into the coolant flow path 138, as shown in FIG. 5, and the coolant flow paths 138a and 138b, as shown in FIG. 9, within the charging connector 13 for circulation through the charging connector and/or return coolant towards the charging system housing 11 from the coolant flow path 138 within the charging connector 13 after circulation through the charging connector 13 by the cooling system based a coolant flow direction enabled by the coolant channel 127. The fluidic connection between the second conduit 134 and the coolant flow path 138 within the charging connector 13 may allow the coolant channel 137 to direct coolant into the coolant flow path 138 within the charging connector 13 for circulation through the charging connector and/or return coolant towards the charging system housing 11 from the coolant flow path 138 within the charging connector 13 after circulation through the charging connector 13 by the cooling system based a coolant flow direction enabled by the coolant channel 137.

FIG. 3 depicts a sectional perspective view of a portion of an exemplary charging cable 12 for the charging system for an electric vehicle of FIG. 1. FIG. 4 depicts a lateral cross-sectional view taken along the length of the body of the charging cable of FIG. 3 between the first and second cable ends 122, 123 respectively. FIG. 5 depicts a perspective view of an exemplary coolant flow path through the exemplary charging cable and the charging connector of FIG. 3. As shown in FIGS. 3-5, cable 12 includes a pair of first conduits 124a, 124b and one second conduit 134. As shown in FIG. 4, each of first conduits 124 a, 124b, second conduit 134, and insulating material 14 are collocated within the tubular body 121 and extend between the first end 122 and the second end 123 within the tubular body 121. As shown in FIG. 5, the second conduit 134 includes a coolant channel 137 that enables flow of coolant in a direction 150 towards the charging connector 13 and each first conduit 124a, 124b includes a coolant channel 127 where each coolant channel 127 enables the flow of coolant in a direction 151 away from the charging connector 13, as shown in FIG. 5. For example, as shown in FIG. 5, the coolant channel 137 may be configured to enable the flow of coolant in a direction 150 from the charging system housing 11 to the charging connector 13, coolant flow path 138 may direct a portion of the coolant into each coolant channel 127 of each of first conduit 124a, 124b, and each coolant channel 127 may be configured to enable the flow of a portion of coolant from the charging connector 13 to the charging system housing 11 after circulation of the coolant through charging connector 13. The coolant channel 137 may allow coolant to reach the charging connector 13 and pass through the charging connector 13 for cooling of the charging connector 13. Each coolant channel 127 of first conduits 124a, 124b may allow coolant to be returned to the portion of the cooling system within the charging system housing 11 from the charging connector 13 for further circulation within the closed loop cooling system.

Alternatively, in an embodiment, each first conduit 124a, 124b includes a coolant channel 127 where each coolant channel 127 enables flow of coolant in a direction 150 towards the charging connector 13 and the second conduit 134 includes a coolant channel 137 that enables the flow of coolant in a direction 151 away from the charging connector 13. For example, each coolant channel 127 of each of first conduit 124a, 124b may be configured to enable the flow of a portion of coolant in a direction 150 from the charging system housing 11 to the charging connector 13, coolant flow path 138 may direct each portion of the coolant into the coolant channel 137, and the coolant channel 137 may be configured to enable the flow of each portion of coolant from the charging connector 13 to the charging system housing 11 after circulation of the coolant through charging connector 13. Each coolant channel 127 of first conduits 124a, 124b may allow coolant to reach the charging connector 13 and pass through the charging connector 13 for cooling of the charging connector 13. The coolant channel 137 may allow coolant to be returned to the portion of the cooling system within the charging system housing 11 from the charging connector 13 for further circulation within the closed loop cooling system.

FIG. 6 depicts a longitudinal cross-sectional view of the charging cable of FIG. 3, showing a first conduit 124a and a second conduit 134. In some embodiments, charging cable 12 may include at least one first fluid disturbance mechanism 130a. In another embodiment, as shown in FIG. 6, charging cable 12 may include at least one first fluid disturbance mechanism 130a and at least one second fluid disturbance mechanism 130b. The first fluid disturbance mechanism 130a and the second fluid disturbance mechanism 130b may include features from fluid disturbance mechanism 131 and/or fluid disturbance mechanism 132, described in more detail in FIGS. 11 and 12. The first fluid disturbance mechanism 130a may be disposed within the coolant channel 127 of first conduit 124a adjacent to the second end 123 of the charging cable 12, as shown in FIG. 6. More specifically, an end of the first fluid disturbance mechanism 130a proximal to the charging connector 13 may be spaced by an axial distance of about 1.18 inches (in) (3 centimeters (cm)) to about 7.87 in (20 cm) from the charging connector 13 within the coolant channel 127. The second fluid disturbance mechanism 130b may be disposed within the coolant channel 127 of first conduit 124a adjacent to the first end 122 of the charging cable 12, as shown in FIG. 6. More specifically, an end of the second fluid disturbance mechanism 130b proximal to the charging system housing 11 may be spaced by an axial distance of about 1.18 in (3 cm) to about 7.87 in (20 cm) from the charging system housing 11 within the coolant channel 127 of first conduit 124a. The ends of the first fluid disturbance mechanism 130a and the second fluid disturbance mechanism 130b proximal to each other may be spaced by an axial distance of about 1.97 in (5 cm) to about 16.4 feet (ft.) (5 meters (m)) from the first fluid disturbance mechanism 130a within the coolant channel 127 of first conduit 124a.

Additionally, the charging cable 12 may also include a first fluid disturbance mechanism 130a and a second fluid disturbance mechanism 130b disposed in the coolant channel 127 of first conduit 124b. The first fluid disturbance mechanism 130a may be disposed within the coolant channel 127 of first conduit 124b adjacent to the second end 123 of the charging cable 12. More specifically, an end of the first fluid disturbance mechanism 130a proximal to the charging connector 13 may be spaced by an axial distance of about 1.18 in (3 cm) to about 7.87 in (20 cm) from the charging connector 13 within the coolant channel 127. The second fluid disturbance mechanism 130b may be disposed within the coolant channel 127 of first conduit 124b adjacent to the first end 122 of the charging cable 12. More specifically, an end of the second fluid disturbance mechanism 130b proximal to the charging system housing 11 may be spaced by an axial distance of about 1.18 in (3 cm) to about 7.87 in (20 cm) from the charging system housing 11 within the coolant channel 127 of first conduit 124b. The ends of the first fluid disturbance mechanism 130a and the second fluid disturbance mechanism 130b proximal to each other by an axial distance of about 1.97 in (5 cm) to about 16.4 ft. (5 m) from the first fluid disturbance mechanism 130a within the coolant channel 127 of first conduit 124b.

Each first fluid disturbance mechanism 130a and second fluid disturbance mechanism 130b may be configured to disturb a thermal boundary layer and a flow of the coolant within the coolant channel 127. For example, each first fluid disturbance mechanism 130a may be configured to disturb a thermal boundary layer and a flow of the coolant within the corresponding coolant channel 127 proximal to the second end 123 of the charging cable 12. Each second fluid disturbance mechanism 130b may be configured to disturb a thermal boundary layer and a flow of the coolant within the corresponding coolant channel 127 proximal to the first end 123 of the charging cable 12. The disturbance of the thermal boundary layer and the flow of the coolant may, thereby, cause increased mixing of the coolant flow through the coolant channel 127. The increased mixing of the coolant may cause the coolant proximal to the conductor 126 to be at a lower temperature than the temperature of the coolant within an undisturbed thermal boundary layer in coolant channels of existing charging cables. Additionally, the lower temperature of the coolant proximal to the conductor may increase the heat transfer effectiveness along a length of coolant channel downstream from the fluid disturbance mechanism 128. In one example, the length of coolant channel with increased heat transfer effectiveness may be an axial distance of about 1.18 in (3 cm) to about 7.87 in (20 cm) downstream from each first fluid disturbance mechanism 130a and second fluid disturbance mechanism 130b. The increased heat transfer effectiveness may allow for improved cooling and reduction of hotspots within charging system 10.

For example, each first fluid disturbance mechanism 130a may be configured to improve cooling of the pins of the charging connector and allow for greater amounts of heat to be carried away from the charging connector 13. The improved cooling of the pins may reduce temperatures and hotspots within the charging connector 13 and the second end 123 of the charging cable 12 and enable the charging connector 13 to handle increased amounts of electrical power without overheating during electrical vehicle charging. Each second fluid disturbance mechanism 130b may be configured to improve cooling of conductor 126 proximal to the charging system housing and allow for greater amounts of heat to be carried away from the first end 122 of the charging cable 12. The improved cooling of the conductor 126 proximal to the charging system housing 11 may reduce temperatures and hotspots proximal to the charging system housing and the first end 122 of the charging cable 12 and enable the charging system 10 to deliver increased amounts of electrical power without overheating during electrical vehicle charging.

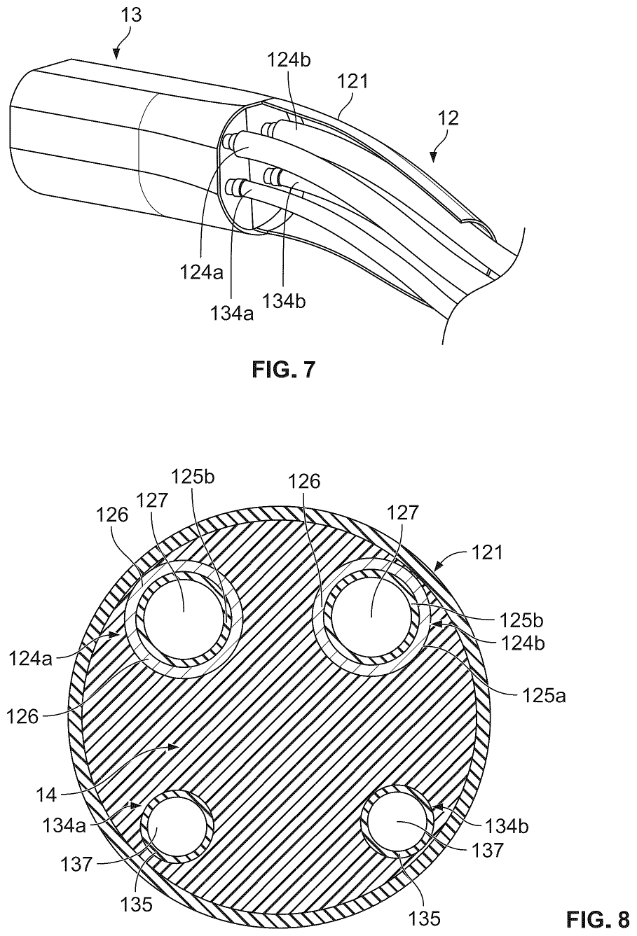

FIG. 7 depicts a sectional perspective view of a portion of an exemplary charging cable 12 for the charging system for an electric vehicle of FIG. 1. FIG. 8 depicts a lateral cross-sectional view taken along the length of the body of the charging cable of FIG. 7 between the first and second cable ends 122, 123 respectively. FIG. 9 depicts a perspective view of an exemplary coolant flow path through the exemplary charging cable and the charging connector of FIG. 7. As shown in FIGS. 7-9, cable 12 includes a pair of first conduits 124a, 124b and a pair of second conduits 134 a, 134 b. As shown in FIG. 8, each of first conduits 124 a, 124b, second conduits 134 a, 134b, and insulating material 14 are collocated within the tubular body 121 and extend between the first end 122 and the second end 123 within the tubular body 121. Each of first conduits 124a, 124b includes a coolant channel 127, where each coolant channel 127 of the pair of first conduits 124a, 124b enables the flow of coolant towards the charging connector and each second conduit 134a, 134b includes a coolant channel 137 where each coolant channel 137 enables the flow of coolant away from the charging connector 13, as shown in FIG. 8. For example, a coolant channel 127 of first conduit 124a may be configured to enable the flow of a portion of coolant in a direction 150 from the portion of cooling system within the charging system housing 11 to the charging connector 13. Coolant channel 137 of second conduit 134a may be in fluid communication with coolant channel 127 of first conduit 124a through coolant flow path 138a, as shown in FIG. 9, and coolant channel 137 of second conduit 134a may be configured to enable the flow of the portion of coolant from coolant channel 127 of first conduit 124a in direction 151 from the charging connector 13 back to the portion of cooling system located within charging system housing 11. A coolant channel 127 of first conduit 124b may be configured to enable the flow of a portion of coolant in a direction 150 from the portion of cooling system within the charging system housing 11 to the charging connector 13. Coolant channel 137 of second conduit 134b may be in fluid communication with coolant channel 127 of first conduit 124b through coolant flow path 138b, as shown in FIG. 9, and coolant channel 137 of second conduit 134b may be configured to enable the flow of the portion of coolant from coolant channel 127 of first conduit 124b in direction 151 from the charging connector 13 back to the portion of cooling system located within charging system housing 11. Each coolant channel 127 may allow coolant to reach the charging connector 13 and circulate through the coolant flow path and the charging connector 13 to enable the cooling of the charging connector 13. Each coolant channel 137 may allow coolant to be returned to the portion of the cooling system within the charging system housing 11 after circulation though the charging connector 13.

Alternatively, each coolant channel 127 of the pair of first conduits 124a, 124b enables the flow of coolant away from the charging connector and each coolant channel 137 of the pair of second conduits 134a, 134b enables the flow of coolant towards the charging connector 13. For example, coolant channel 137 of second conduit 134a may be configured to enable the flow of a portion of coolant in a direction 150 from the portion of cooling system within the charging system housing 11 to the charging connector 13. Coolant channel 127 of first conduit 124a may be in fluid communication with coolant channel 137 of second conduit 134a through coolant flow path 138a, as shown in FIG. 9, and coolant channel 127 of first conduit 124a may be configured to enable the flow of the portion of coolant from coolant channel 137 of second conduit 134a in direction 151 from the charging connector 13 back to the portion of cooling system located within charging system housing 11. Coolant channel 137 of second conduit 134b may be configured to enable the flow of a portion of coolant in a direction 150 from the portion of cooling system within the charging system housing 11 to the charging connector 13. Coolant channel 127 of first conduit 124b may be in fluid communication with coolant channel 137 of second conduit 134b through coolant flow path 138b, as shown in FIG. 9, and coolant channel 127 of first conduit 124b may be configured to enable the flow of the portion of coolant from coolant channel 137 of second conduit 134b in direction 151 from the charging connector 13 back to the portion of cooling system located within charging system housing 11. Each coolant channel 137 may allow coolant to reach the charging connector 13 and circulate through the coolant flow path and the charging connector 13 to enable the cooling of the charging connector 13. Each coolant channel 127 may allow coolant to be returned to the portion of the cooling system within the charging system housing 11 after circulation though the charging connector 13.

FIG. 10 depicts a longitudinal cross-sectional view of the charging cable of FIG. 7, showing a first conduit 124a and a second conduit 134a. As shown in FIG. 10, charging cable 12 may include at least one first fluid disturbance mechanism 130a and at least one second fluid disturbance mechanism 130b. The first fluid disturbance mechanism 130a and the second fluid disturbance mechanism 130b may each include features from fluid disturbance mechanism 131 and/or fluid disturbance mechanism 132, described in more detail in FIGS. 11 and 12. The first fluid disturbance mechanism 130a may be disposed within the coolant channel 127 of first conduit 124a adjacent to the second end 123 of the charging cable 12, as shown in FIG. 10. More specifically, an end of the first fluid disturbance mechanism 130a proximal to the charging connector 13 may be spaced by an axial distance of about 1.18 in (3 cm) to about 7.87 in (20 cm) from the charging connector 13 within the coolant channel 127. The second fluid disturbance mechanism 130b may be disposed within the coolant channel 137 of second conduit 134a adjacent to the first end 122 of the charging cable 12, as shown in FIG. 10. More specifically, an end of the second fluid disturbance mechanism 130b proximal to the charging system housing may be spaced by an axial distance of about 1.18 in (3 cm) to about 7.87 in (20 cm) from the charging system housing 11 within the coolant channel 137 of second conduit 134a. The ends of the first fluid disturbance mechanism 130a and the second fluid disturbance mechanism 130b proximal to each other may be spaced by an axial distance of about 1.97 in (5 cm) to about 16.4 ft. (5 m).

Additionally, the charging cable 12 may also include a first fluid disturbance mechanism 130a disposed in the coolant channel 127 of first conduit 124b and a second fluid disturbance mechanism 130b disposed in the coolant channel 137 of second conduit 134b. The first fluid disturbance mechanism 130a may be disposed within the coolant channel 127 of first conduit 124b adjacent to the second end 123 of the charging cable 12. More specifically, an end of the first fluid disturbance mechanism 130a proximal to the charging connector 13 may be spaced by an axial distance of about 1.18 in (3 cm) to about 7.87 in (20 cm) from the charging connector 13 within the coolant channel 127. The second fluid disturbance mechanism 130b may be disposed within the coolant channel 137 of second conduit 134b adjacent to the first end 122 of the charging cable 12. More specifically, an end of the second fluid disturbance mechanism 130b proximal to the charging system housing 11 may be spaced by an axial distance of about 1.18 in (3 cm) to about 7.87 in (20 cm) from the charging system housing 11 within the coolant channel 137 of first conduit 134b. The ends of the first fluid disturbance mechanism 130a and the second fluid disturbance mechanism 130b proximal to each other may be spaced by an axial distance of about 1.97 in (5 cm) to about 16.4 ft. (5 m).

Each first fluid disturbance mechanism 130a and second fluid disturbance mechanism 130b may be configured to disturb a thermal boundary layer and a flow of the coolant within the coolant channel 127 and coolant channel 137, respectively. For example, each first fluid disturbance mechanism 130a may be configured to disturb a thermal boundary layer and a flow of the coolant within the corresponding coolant channel 127 proximal to the second end 123 of the charging cable 12. Each second fluid disturbance mechanism 130b may be configured to disturb a thermal boundary layer and a flow of the coolant within the corresponding coolant channel 137 proximal to the first end 123 of the charging cable 12. The disturbance of the thermal boundary layer and the flow of the coolant may, thereby, cause increased mixing of the coolant flow through the coolant channel 127 and coolant channel 137. The increased mixing of the coolant may cause the coolant proximal to the conductor 126 to be at a lower temperature than the temperature of the coolant within an undisturbed thermal boundary layer in coolant channels within existing charging cables. Additionally, the lower temperature of the coolant proximal to the conductor may increase the heat transfer effectiveness along a length of coolant channel downstream from the first fluid disturbance mechanism 130a and the fluid disturbance mechanism 130b. In one example, the length of coolant channel with increased heat transfer effectiveness may be an axial distance of about 1.18 in (3 cm) to about 7.87 in (20 cm) downstream from each first fluid disturbance mechanism 130a and second fluid disturbance mechanism 130b. The increased heat transfer effectiveness may allow for improved cooling and reduction of hotspots within charging system 10.

For example, each first fluid disturbance mechanism 130a may be configured to improve cooling of the pins of the charging connector and allow for greater amounts of heat to be carried away from the charging connector 13. The improved cooling of the pins may reduce temperatures and hotspots within the charging connector 13 and the second end 123 of the charging cable 12 and enable the charging connector 130 to handle increased amounts of electrical power without overheating during electrical vehicle charging. Each second fluid disturbance mechanism 130b may be configured to improve cooling of conductor 126 proximal to the charging system housing 11 and allow for greater amounts of heat to be carried away from the first end 122 of the charging cable 12. The improved cooling of the conductor 126 proximal to the charging system housing 11 may reduce temperatures and hotspots proximal to the charging system housing 11 and the first end 122 of the charging cable 12 and enable the charging system 10 to deliver increased amounts of electrical power without overheating during electrical vehicle charging.

FIG. 11A depicts a magnified detailed view of area 11A of FIG. 10 showing a portion of a first conduit 124a with an exemplary fluid disturbance mechanism 131 included in the coolant channel 127 of the first conduit 124a. Conduit 124a includes the chamber 190 defined by walls 125a, 125b with conductor 126 in the chamber 190, as described above. The second wall 125b defines a coolant channel 127. Additionally, conduit 124a may include a fluid disturbance mechanism 131 disposed within the coolant channel 127. In an embodiment, the fluid disturbance mechanism 131 may comprise a helical shaped member. As shown in FIG. 11A, the lateral dimension of the helical member is substantially the same as the diameter/lateral dimension of the coolant channel 127. In an embodiment, the fluid disturbance member 131 extend along an axial length of about 1.8 in (5 cm) to about 11.8 in. (30 cm). Additionally, each coil of the helical shape of the fluid disturbance mechanism 128 may be separated axially/longitudinally by about 0.19 in (0.5 cm) to about 0.78 in (2 cm). The helical shape may include an internal lateral dimension/diameter of about 1.18 in. (3 cm) to about 3.15 in. (8 cm) and an external diameter of about 2.36 in. (6 cm) to about 4.72 in. (12 cm). In some embodiments, the external diameter of the fluid disturbance mechanism 131 may be substantially similar to an internal diameter of the coolant channel 127 to allow the fluid disturbance mechanism 131 to be positioned in contact with a wall 125b of the coolant channel. The fluid disturbance mechanism 131 may have a friction fit against the wall 125b and, as a result, maintains stationary in the desired location in the coolant channel 127. The fluid disturbance mechanism 131 may be positioned within coolant channel 127 along any portion of coolant channel 127, such as exemplary positions as described in FIGS. 6 and 10. The fluid disturbance mechanism 131 may be positioned within a coolant channel 137 of a second conduit 134 along any portion of coolant channel 137, such as exemplary positions as described in FIG. 10. Additionally, charging cable 12 may include any number of fluid disturbance mechanisms located in at least one coolant channel 127 and/or at least one coolant channel 137.

FIG. 11B depicts a magnified detailed view of area 11A of FIG. 10 showing a portion of a first conduit 124a with an exemplary fluid disturbance mechanism 132 included in the coolant channel 127 of the first conduit 124a. Conduit 124a may comprise a first conduit wall 125a, a second conduit wall 125b, a conductor 126, and a coolant channel 127, as described above. Additionally, conduit 124a may include a fluid disturbance mechanism 132 disposed within the coolant channel 127. In an embodiment, the fluid disturbance mechanism 132 may comprise at least one ring 133. The at least one ring 133 may include any suitable number of rings to disturb a thermal boundary layer and the flow of the coolant within the coolant channel 127. For example, as shown in FIG. 11B, the at least one ring comprises six rings. The fluid disturbance mechanism 132 may extend about 1.8 in (5 cm) to about 11.8 in. (30 cm) along the axial length of the coolant channel 127. Additionally, each of the at least one ring 133 may be separated axially/longitudinally by about 0.19 in (0.5 cm) to about 0.78 in (2 cm). Each of the at least one ring 133 may include an internal lateral dimension/diameter of about 1.18 in. (3 cm) to about 3.15 in. (8 cm) and an external diameter of about 2.36 in. (6 cm) to about 4.72 in. (12 cm). In some embodiments, the external diameter of each ring 133 may be substantially similar to an internal diameter of the coolant channel 127 to allow the fluid disturbance mechanism 132 and/or at least one ring 130 to be positioned against a wall of the coolant channel, such as an inner wall of the second conduit wall 125b, and allow the at least one ring 133 to be friction fit against the wall to allow the at least one ring 133 to stay in position. The fluid disturbance mechanism 132 may be positioned within coolant channel 127 along any portion of coolant channel 127, such as exemplary positions as described in FIGS. 6 and 10. Additionally, the fluid disturbance mechanism 132 may be positioned within coolant channel 137 along any portion of coolant channel 137, such as exemplary positions as described in FIG. 10. Charging cable 12 may include any number of disturbance mechanisms 132 located within at least one coolant channel 127 and/or at least one coolant channel 137.

While the disclosure has been described with reference to preferred embodiments, it will be understood by those skilled in the art that various changes may be made, and equivalents may be substituted for the elements thereof without departing from the scope of the disclosure. In addition, many modifications may be made to adapt the teaching of the disclosure to particular use, application, manufacturing conditions, use conditions, composition, medium, size, and/or materials without departing from the essential scope and spirit of the disclosure. Therefore, it is intended that this disclosure is not limited to the exemplary embodiments and best mode contemplated for carrying out the embodiments of this disclosure as described herein. Since many modifications, variations, and changes in detail can be made to the described examples, it is intended that all matters in the preceding description and shown in the accompanying figures be interpreted as illustrative and not in a limiting sense.

1. A charging cable for electric vehicles, comprising:
a tubular housing, the tubular housing comprising a first end and a second end;
a plurality of conduits extending between the first end and the second end within the tubular housing, the plurality of conduits comprising:
a plurality of first conduits, each first conduit comprising a first coolant channel configured to enable the flow of coolant between the first end and the second end in a first direction; and
at least one second conduit, each second conduit comprising a second coolant channel configured to enable the flow of coolant between the first end and the second end in a second direction; and
at least one fluid disturbance mechanism disposed within at least one of each first coolant channel and each second coolant channel.

2. The charging cable of claim 1, wherein the fluid disturbance mechanism comprises a helical shape configured to disturb a thermal boundary layer and a flow of the coolant.

3. The charging cable of claim 1, wherein the fluid disturbance mechanism comprises at least one ring configured to disturb a thermal boundary layer and a flow of the coolant.

4. The charging cable of claim 1, wherein:
the plurality of first conduits comprises a pair of first conduits and each first coolant channel is configured to enable the flow of coolant in the first direction from the first end to the second end; and
the at least one second conduit comprises a pair of second conduits, and each second coolant channel is configured to enable the flow of coolant in the second direction from the second end to the first end.

5. The charging cable of claim 4, wherein the at least one fluid disturbance mechanism comprises a first fluid disturbance mechanism disposed within each first coolant channel and a second fluid disturbance mechanism disposed within each second cooling channel.

6. The charging cable of claim 5, wherein the first fluid disturbance mechanism is disposed within each first coolant channel adjacent to the second end of the tubular housing.

7. The charging cable of claim 6, wherein the second fluid disturbance mechanism is disposed within each second coolant channel adjacent to the first end of the tubular housing.

8. The charging cable of claim 1, wherein the plurality of first conduits comprises a pair of first conduits and each first coolant channel is configured to enable the flow of coolant in the first direction from the second end to the first end.

9. The charging cable of claim 8, wherein the at least one fluid disturbance mechanism comprises a first fluid disturbance mechanism disposed within each first coolant channel adjacent to the second end and a second fluid disturbance mechanism disposed within each first coolant channel adjacent to the first end.

10. A charging cable for electric vehicles, comprising:
a tubular housing, the tubular housing comprising a proximal end and a distal end;
a plurality of conduits extending between the proximal end and the distal end within the tubular housing, the plurality of conduits comprising:
a plurality of first conduits, each first conduit comprising a first coolant channel configured to enable the flow of coolant between the proximal end and the distal end; and
at least one second conduit, each second conduit comprising a second coolant channel configured to enable the flow of coolant between the proximal end and the distal end in a second direction;
at least one fluid disturbance mechanism disposed within at least one of each first coolant channel and each second coolant channel; and
a charging connector coupled to the distal end of the tubular housing, the charging connected configured to couple to an electric vehicle.

11. The charging cable of claim 10, wherein the fluid disturbance mechanism comprises a helical shape configured to disturb a thermal boundary layer and a flow of the coolant.

12. The charging cable of claim 10, wherein the fluid disturbance mechanism comprises at least one ring configured to disturb a thermal boundary layer and a flow of the coolant.

13. The charging cable of claim 10, wherein,
the plurality of first conduits comprises a pair of first conduits and each first coolant channel is configured to enable the flow of coolant in the first direction from the first end to the second end; and
the at least one second conduit comprises a pair of second conduits, and each second coolant channel is configured to enable the flow of coolant in the second direction from the second end to the first end.

14. The charging cable of claim 13, wherein the at least one fluid disturbance mechanism comprises a first fluid disturbance mechanism disposed within each first coolant channel and a second fluid disturbance mechanism disposed within each second cooling channel.

15. The charging cable of claim 14, wherein the first fluid disturbance mechanism is disposed within each first coolant channel adjacent to the second end of the tubular housing.

16. The charging cable of claim 15, wherein the second fluid disturbance mechanism is disposed within each second coolant channel adjacent to the first end of the tubular housing.

17. The charging cable of claim 10, wherein the plurality of first conduits comprises a pair of first conduits and each first coolant channel is configured to enable the flow of coolant in the first direction from the second end to the first end.

18. The charging cable of claim 17, wherein the at least one fluid disturbance mechanism comprises a first fluid disturbance mechanism disposed within each first coolant channel adjacent to the second end and a second fluid disturbance mechanism disposed within each first coolant channel adjacent to the first end.

19. A charging system for an electric vehicle, comprising:
a charging system housing;
at least one charging cable coupled to the charging system housing, the at least one charging cable comprising:
a tubular housing, the tubular housing comprising a proximal end and a distal end;
a plurality of conduits extending between the proximal end and the distal end within the tubular housing, the plurality of conduits comprising:
a plurality of first conduits, each first conduit comprising a first coolant channel configured to enable the flow of coolant between the proximal end and the distal end in a first direction; and
at least one second conduit, each second conduit comprising a second coolant channel configured to enable the flow of coolant between the proximal end and the distal end in a second direction, opposite of the first direction;
at least one fluid disturbance mechanism disposed within at least one of each
first coolant channel and each second coolant channel; and
a charging connector coupled to the distal end of the tubular housing, the charging connector configured to couple to the electric vehicle to supply the electrical power to the electric vehicle.

20. The charging system of claim 19, wherein the fluid disturbance mechanism comprises a helical shape positioned against a wall of the coolant channel.
